(19) United States
(12) Patent Application Publication
(10) Pub. No.: US 2026/0360282 A1
(43) Pub. Date: Nov. 12, 2026

(54) TRAINING MANIKIN AND PELVIS TRAINING ASSEMBLY THEREFOR

(71) Applicant: North American Rescue, LLC, Greer, SC (US)

(72) Inventors: Benjamin Scott Clift, Louisville, KY (US); Christopher Michael Kuharik, Frankfort, KY (US); William Adams, Shelbyville, KY (US); Keary Miller, Eastpoint, FL (US)

(21) Appl. No.: 19/199,602

(22) Filed: May 6, 2025

(51) Int. Cl. G09B 23/32

(52) U.S. Cl. CPC G09B 23/32

(57) ABSTRACT

A pelvis training assembly includes a central frame segment and an ilium segment attached to the central frame segment. The ilium segment includes a fixed scaffold, a movable scaffold, and a tactile joint. The fixed scaffold extends from the central frame segment. The movable scaffold is spaced apart from the central frame segment. The tactile joint defines a hinge axis and pivotably attaches the movable scaffold to the fixed scaffold to selectively pivot about the hinge axis. The tactile joint includes a biased arm supported on and biased outward from one of the fixed scaffold and the movable scaffold. The tactile joint also includes a contact arm supported on an opposite of the fixed scaffold and the movable scaffold in frictional contact with the biased arm to generate haptic feedback with pivoting of the tactile joint about the hinge axis.

### FIELD OF THE DISCLOSURE

The present subject matter relates generally to medical training devices, and more particularly to assemblies for assessing pelvic health.

### BACKGROUND OF THE DISCLOSURE

Crepitus hip is characterized by rough movement of the hip joint accompanied by what has been described as “crunchy” or “grinding” when moving the hip. It may further be characterized as movement outside that of a normal (i.e., healthy) joint. Although often associated with arthritis, it may indicate other conditions or general damage to the hip joint (e.g., a broken pelvis or hip). Crepitus hip is often very painful and can influence how a patient should be treated. However, patients are often unaware or unable to explicitly tell someone if they have such a condition.

Medical care providers, and especially first responders involved in military and emergency medicine, encounter patients with a wide variety of unknown conditions. As a result, such care providers often need to assess a patient's condition before proceeding to treating or transporting the patient. For instance, if a lower extremity fracture is suspected, assessing pelvic stability is often the first step in determining a course of action (e.g., for stabilization of the lower extremity fracture). This may include attempting to determine if a patient has crepitus hip.

Crepitus hip simulators have been attempted for training medical providers on how to identify if a patient has crepitus hip. Typically, existing crepitus hip simulators are bolt-on modules for other, largely static, pelvic models. Unfortunately, though, such existing devices present a number of drawbacks. In particular, existing devices are generally unable to accurately simulate treating a live patient. For instance, they often fail to provide any tactile feedback or an accurate range of motion that would accompany a broken pelvis or hip. This may lead to trainees being inadequately prepared for assessing conditions, such as crepitus hip.

Accordingly, it may be useful to provide a manikin or assembly addressing one or more of the above issues. In particular, systems or assemblies that provide a more accurate training experience or live (e.g., tactile) feedback during training would be advantageous.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a pelvis training assembly is provided. The pelvis training assembly may include a central frame segment and an ilium segment attached to the central frame segment. The ilium segment may include a fixed scaffold, a movable scaffold, and a tactile joint. The fixed scaffold may extend from the central frame segment. The movable scaffold may be spaced apart from the central frame segment. The tactile joint may define a hinge axis and pivotably attach the movable scaffold to the fixed scaffold to selectively pivot about the hinge axis. The tactile joint may include a biased arm supported on and biased outward from one of the fixed scaffold and the movable scaffold. The tactile joint may further include a contact arm supported on an opposite of the fixed scaffold and the movable scaffold in frictional contact with the biased arm to generate haptic feedback with pivoting of the tactile joint about the hinge axis.

In another exemplary aspect of the present disclosure, a training manikin is provided. The training manikin may include a manikin body including a simulated skeletal frame, a torso section extending about a first portion of the simulated skeletal frame, and a pelvis section extending about a second portion of the skeletal frame below the torso portion. The pelvis section may include a central frame segment of the simulated skeletal frame and an ilium segment attached to the central frame segment. The ilium segment may include a fixed scaffold, a movable scaffold, and a tactile joint. The fixed scaffold may extend from the central frame segment. The movable scaffold may be spaced apart from the central frame segment. The tactile joint may define a hinge axis and pivotably attach the movable scaffold to the fixed scaffold to selectively pivot about the hinge axis. The tactile joint may include a biased arm supported on and biased outward from one of the fixed scaffold and the movable scaffold. The tactile joint may further include a contact arm supported on an opposite of the fixed scaffold and the movable scaffold in frictional contact with the biased arm to generate haptic feedback with pivoting of the tactile joint about the hinge axis.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a training manikin, including a pelvis assembly, according to exemplary embodiments of the present disclosure;

FIG. 2 provides a perspective view of a pelvis assembly according to exemplary embodiments of the present disclosure;

FIG. 3 provides a cross-sectional perspective view of the exemplary pelvis assembly of FIG. 2;

FIG. 4 provides another cross-sectional perspective view of the exemplary pelvis assembly of FIG. 2;

FIG. 5 provides another cross-sectional perspective view of the exemplary pelvis assembly of FIG. 2, wherein movement of a portion of the assembly is illustrated for clarity;

FIG. 6 provides a perspective view of a pelvis assembly according to exemplary embodiments of the present disclosure; and

FIG. 7 provides a perspective view of a portion of the exemplary pelvis assembly of FIG. 6.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents. The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

Unless specified otherwise, terms such as “inner” and “outer” refer to relative directions with respect to the interior and exterior of a training manikin. For example, “inner” or “inward” refers to the direction towards the interior of the training manikin. Terms such as “left,” “right,” “front,” “back,” “top,” or “bottom” are used with reference to the artificial perspective of the manikin. For example, the manikin arranged upright as if standing would include a “front” that generally corresponds to the chest or abdomen segments of the manikin.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Generally, the present disclosure provides a training tool or assembly (for or as part of a larger manikin) permitting users to learn how to assess a simulated patient's pelvic health. Aspects of the present disclosure may include a central frame segment and an ilium segment to mimic a patient's hip. The ilium segment, in particular, may include a movable element (e.g., scaffold piece) that can move or pivot relative to a fixed element (e.g., scaffold piece). A tactile joint may connect these elements and generate a haptic or audible feedback, such as in response to the movable piece pivoting relative to the fixed piece. This feedback may be generated, for instance, by the interaction between a biased arm moving along a contact arm. In turn, a trainee may advantageously experience feedback for intra-pelvis movement. Moreover, the tool or assembly may accurately mimic a real-life bodily response to conditions such as a fractured pelvis or crepitus hip (e.g., without requiring one or more electronic components).

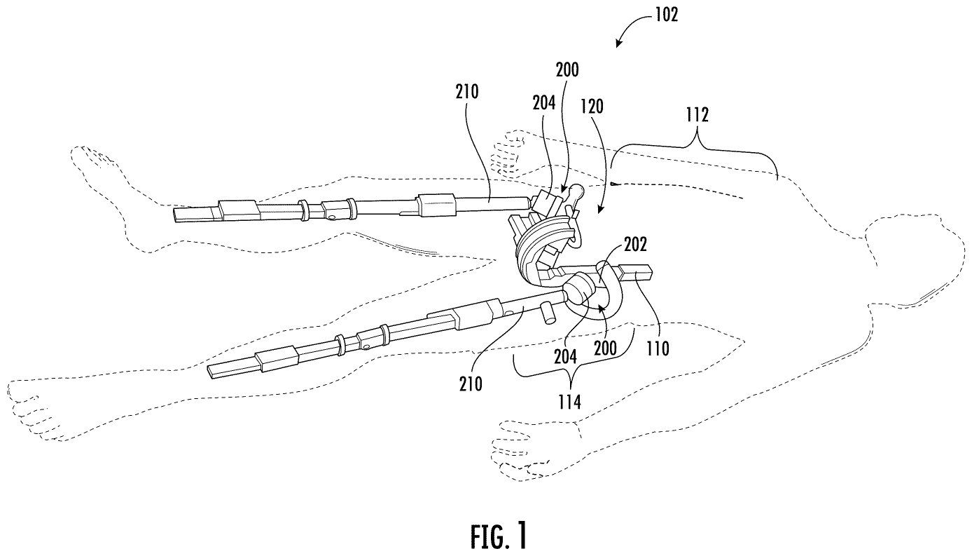

Referring now to the figures, FIG. 1 provides a perspective view of a training manikin 102. As used in the current disclosure, manikin 102 is a life-sized, human-shaped model designed to replicate the anatomy, physiology a real person. The manikin 102 may be a tool for medical training, providing students, healthcare professionals, and emergency responders with a realistic platform to practice a wide range of medical procedures. These procedures may include trauma care, wound treatment, first-aid techniques, surgical techniques, life-saving interventions, and the like.

In an embodiment, the manikin 102 may be constructed from silicone or similar substances to closely mimic the texture, flexibility, and resilience of human skin and soft tissues. The use of silicone may allow for a more lifelike tactile experience. In some cases, the manikin 102 may include internal structures, such as simulated bones, muscles, organs, and the like. In particular, the manikin 102 includes a simulated skeletal frame 110 made up of one or more rigid simulated bones, which may generally match or correspond to the overall skeletal structure of a human body (e.g., along the spine, arms, or legs and without requiring a unique simulated bone for each bone of a human body). Moreover, an outer skin or jacket layer (e.g., simulating human skin, muscle, and other tissues) may be provided over or on top of the simulated skeletal frame 110. Although the manikin 102 may exclude or make removable certain simulated body parts (e.g., to more closely mimic disabled individuals or amputees), the manikin 102 may at least include a torso section 112 extending about at least one (e.g., first) portion of the skeletal frame 110 and a pelvis section 114 extending about at least another (e.g., second) portion of the skeletal frame 110 (e.g., below the torso portion).

Within or as part of the pelvis section 114, a pelvis assembly 120 may be provided and may simulate a pelvic girdle. As will be described in greater detail below, the ilium segment 124 may include one or more scaffolds (e.g., rigid, simulated-bone elements) that are movable (e.g., selectively movable) relative to each other.

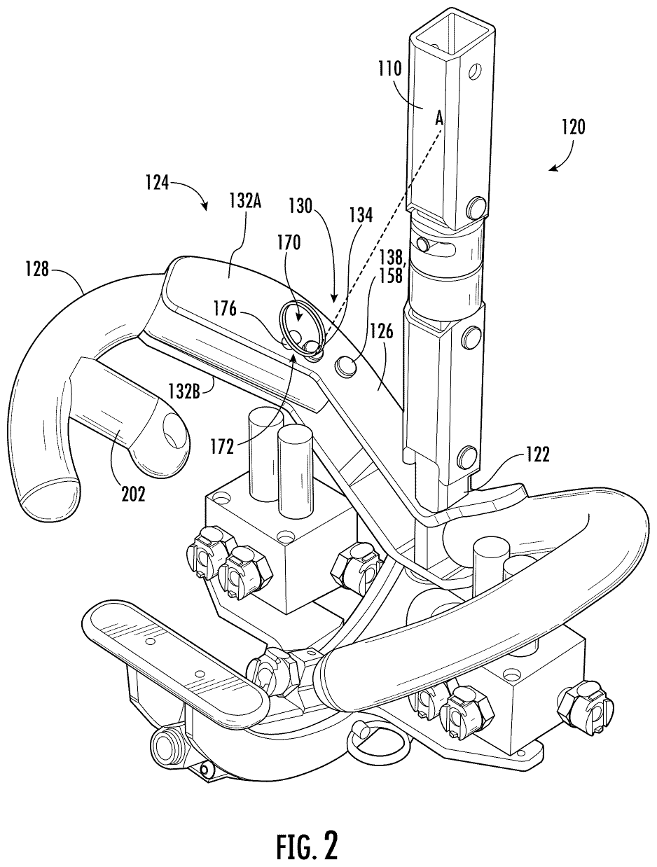

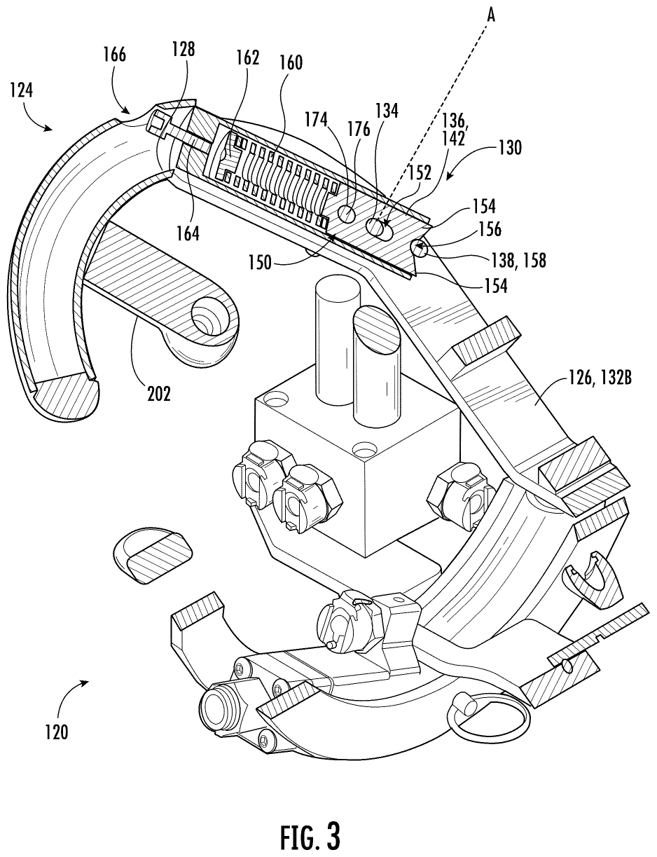

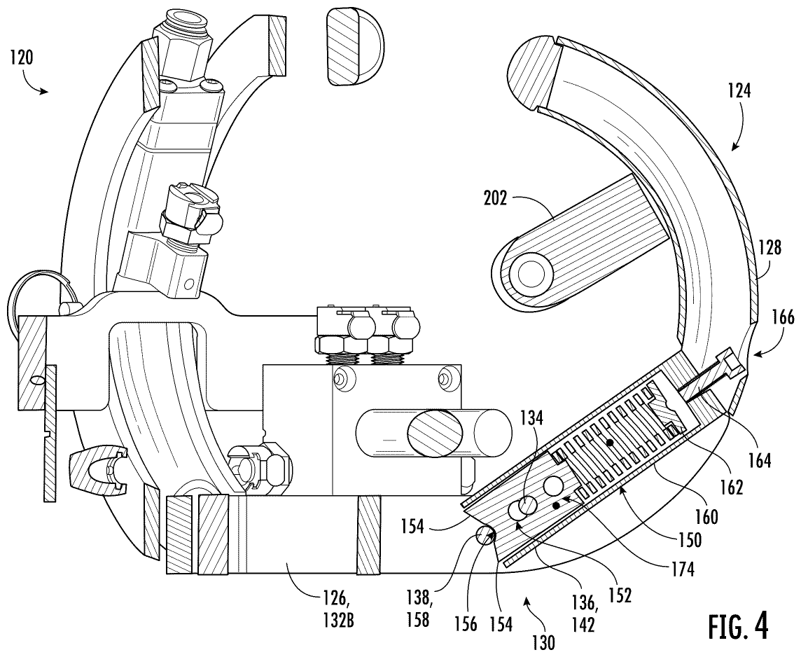

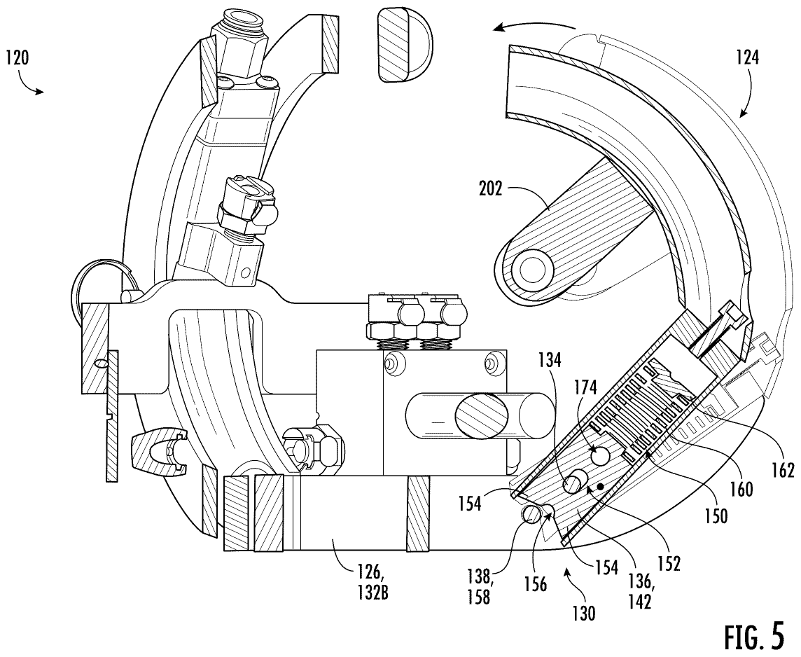

Turning now generally to FIGS. 2 through 7, exemplary embodiments of a pelvis assembly 120 (e.g., isolated from the rest of manikin 102—FIG. 1) are illustrated. As shown, the pelvis assembly 120 may generally include a central frame segment 122 and an ilium segment 124. For instance, the central frame segment 122 (e.g., formed as part of the skeletal frame 110) may be provided to simulate a portion of a patient's spine or sacrum. The ilium segment 124 may attach to or extend from the central frame segment 122. The ilium segment 124 itself may include a fixed scaffold 126 and a movable scaffold 128, along with a tactile joint 130 that attaches or connects the two scaffolds 126, 128 (e.g., at least in part). A hinge axis A is defined at the tactile joint 130 and provides an axis about which the movable scaffold 128 may pivot.

Turning now especially to FIGS. 2 through 5, in some embodiments, the fixed scaffold 126 includes one or more rigid plates extending (e.g., upward and outward) from the central frame segment 122. For instance, the fixed scaffold 126 may include an upper plate 132A and a lower plate 132B spaced apart from the upper plate 132A. The upper and lower plates 132A, 132B may be parallel to each other. Optionally, one or more connecting plates 182 may be provided to secure or maintain the positioning between the upper and lower plates 132A, 132B.

In contrast to the fixed scaffold 126, the movable scaffold 128 may be spaced apart from the central frame segment 122. For instance, the movable scaffold 128 may be pivotably attached to the fixed scaffold 126 at an upper portion of the fixed scaffold 126 (e.g., such that the movable scaffold 128 does not contact the central frame segment 122). In some embodiments, the movable scaffold 128 may be held between the upper and lower plates 132A, 132B. Optionally, the movable scaffold 128 includes a tubular body. As shown, the tubular body may further be bent or curved to extend outward and inward from the fixed scaffold 126 to a terminal end, thereby mimicking the upper portion of a human ilium bone.

As noted above, the tactile joint 130 may define the hinge axis A and pivotably attach the movable scaffold 128 to the fixed scaffold 126. As shown, the tactile joint 130 includes a biased arm 136 and a contact arm 138, which together interact to generate haptic feedback. In some embodiments, the tactile joint 130 may further include a hinge pin 134 holding the movable scaffold 128 to the fixed scaffold 126. Specifically, the hinge pin 134 may extend along the hinge axis A. In the illustrated embodiments, the hinge pin 134 extends, in particular, between the upper plate 132A and the lower plate 132B of the fixed scaffold 126, as well as through a portion of the movable scaffold 128 (e.g., which is sandwiched between the upper and lower plates 132A, 132B). In turn, the movable scaffold 128 may pivot between the upper and lower plates 132A, 132B about the hinge pin 134 and the hinge axis A.

Generally, the biased arm 136 is supported on and biased relatively outward (e.g., away) from one of the fixed scaffold 126 and the movable scaffold 128 while the contact arm 138 is supported on the opposite scaffold. In other words, if the biased arm 136 is supported on the fixed scaffold 126 (and biased outward or away from the same), the contact arm 138 is supported on the movable scaffold 128, and vice versa. In the illustrated embodiments of FIGS. 2 through 5, the biased arm 136 is supported on the movable scaffold 128 while the contact arm 138 is supported on the fixed scaffold 126.

The biased arm 136 may include a suitable plunger for contacting or engaging the contact arm 138. The plunger may be held, for instance, within a housing chamber 150 defined by a portion of the movable scaffold 128. Optionally, the hinge pin 134 may extend through the housing chamber 150 and through plunger. As shown, an enclosed portion of the plunger may define a pin aperture 152 through which the hinge pin 134 extends. In order to permit linear or biased movement of the plunger, however, the pin aperture 152 may include an elliptical or otherwise oval-shaped profile such that the plunger is permitted to slide relative to the hinge pin 134.

In certain embodiments, the biased arm 136 includes a tapered plunger 142. As shown, the tapered plunger 142 may have a pair of prongs 154 that each extend from a centered recess 156. The prongs 154 may extend outward from the centered recess 156 with interior ramped surfaces such that a generally V-shaped profile is formed. In additional or alternative embodiments, the contact arm 138 may include a static pin 158 (e.g., cylindrical pin). For instance, the static pin 158 may extend parallel to the hinge axis A (e.g., while being radially spaced apart from the hinge axis A), such as between the upper and lower plates 132A, 132B.

When assembled, the interior ramped surfaces of the prongs 154 of the biased arm 136 may bound the contact arm 138. At a neutral, unpivoted position, the contact arm 138 (e.g., static pin 158) may sit at the centered recess 156 or apex of the V-shaped profile. In optional embodiments, the centered recess 156 includes or defines an arcuate notch that is matched to a sub-portion of the static pin 158. In turn, at a neutral, unpivoted position, the static pin 158 may sit within the centered recess 156. Moreover, an initial “breaking” force may be required to pivot the movable scaffold 128 from the neutral, unpivoted position.

When assembled, the biased arm 136 may be biased toward the contact arm 138. For instance, the biased arm 136 may be biased perpendicular to the hinge axis A, as shown. An elastic element or spring 160 may provide the biasing force. Generally, any suitable biasing spring 160 may be provided. For instance, the biasing spring 160 may include or be provided as a helical compression spring, leaf spring, pneumatic cylinder, deformable or elastic polymer, etc.

In the illustrated embodiments, the biasing spring 160 is held within the housing chamber 150 defined by the movable scaffold 128. For instance, the biasing spring 160 may be disposed between a closed end of the housing chamber 150 and the plunger of the biased arm 136, which itself extends through an open end of the housing chamber 150. Optionally, a spring seat or cap 162 may further be disposed between the closed end of the housing chamber 150 and the biasing spring 160, such as to tension the biasing spring 160 within the housing chamber 150. For instance, a tensioning screw 164 extending through the closed end of the housing chamber 150 may be rotatably disposed in contact or engagement with the spring cap 162 to adjust the linear distance between the closed end and the biasing spring 160, and thereby apply a desired tension to the biasing spring 160. As shown, an access aperture 166 may be defined through the movable scaffold 128 to permit access to the tensioning screw 164.

In certain embodiments, a lockout assembly 170 is included with the ilium segment 124. For instance, a pair of grooves may be provided between the fixed and movable scaffolds 126, 128 to receive a latch 176, locking the scaffolds 126, 128 or otherwise restricting relative movement thereof. In the illustrated embodiments, a first groove 172 is defined on the fixed scaffold 126. Specifically, the first groove 172 is defined by a pair of aligned apertures defined through the upper plate 132A and the lower plate 132B, as shown. A second groove 174 is defined on the movable scaffold 128 (e.g., by another pair of aligned apertures defined through the tubular body defining the housing chamber 150). The first groove 172 and the second groove 174 may be defined parallel to the hinge axis A. Moreover, in a neutral, unpivoted position, the first and second grooves 172, 174 may be mutually aligned. The latch 176 may include or be provided as a slidable pin that is slidable parallel to the hinge axis A. In turn, at the neutral, unpivoted position, the latch 176 may be simultaneously received through the first groove 172 and the second groove 174 to lock the movable scaffold 128 relative to the fixed scaffold 126.

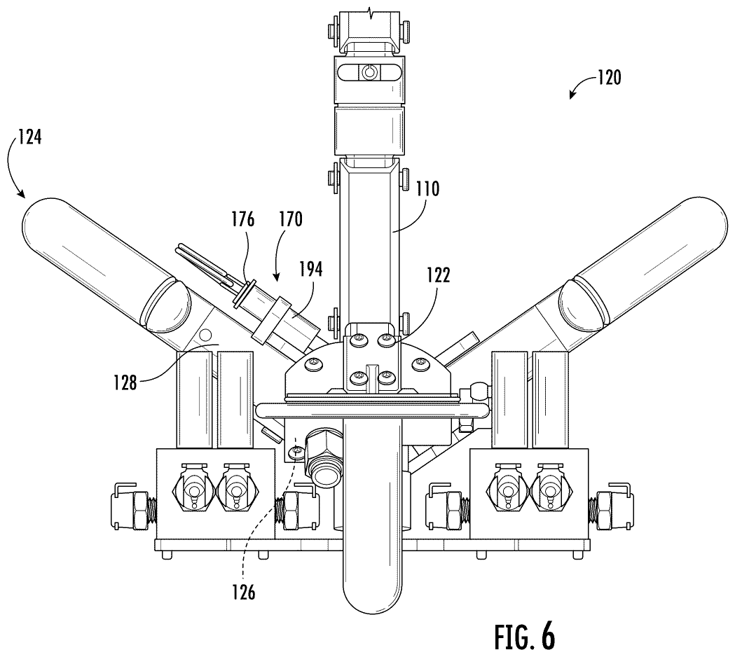

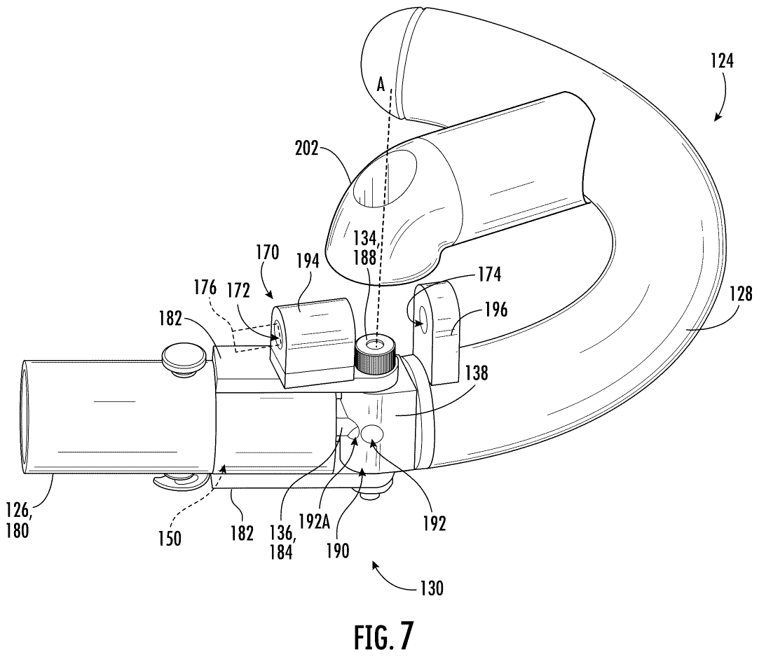

Turning now especially to FIGS. 6 through 7, in some embodiments, the fixed scaffold 126 includes one or more rigid tubes extending (e.g., upward and outward) from the central frame segment 122. For instance, the fixed scaffold 126 may include a primary tube 180 fixed relative to the central frame segment 122.

In contrast to the fixed scaffold 126, the movable scaffold 128 may be spaced apart from the central frame segment 122. For instance, the movable scaffold 128 may be pivotably attached to the fixed scaffold 126 at an upper portion of the fixed scaffold 126 (e.g., such that the movable scaffold 128 does not contact the central frame segment 122). In some embodiments, the movable scaffold 128 may be held between a pair of connecting plates 182. Optionally, the movable scaffold 128 includes a tubular body. As shown, the tubular body may further be bent or curved to extend outward and inward from the fixed scaffold 126 to a terminal end, thereby mimicking the upper portion of a human ilium bone.

As noted above, the tactile joint 130 may define the hinge axis A and pivotably attach the movable scaffold 128 to the fixed scaffold 126. As shown, the tactile joint 130 includes a biased arm 136 and a contact arm 138, which together interact to generate haptic feedback. In some embodiments, the tactile joint 130 may further include a hinge pin 134 holding the movable scaffold 128 to the fixed scaffold 126. Specifically, the hinge pin 134 may extend along the hinge axis A. In the illustrated embodiments, the hinge pin 134 extends, in particular, between the connecting plates 182 of the fixed scaffold 126, as well as through a shoulder of the contact arm 138 that is fixed to the movable scaffold 128 (e.g., which may be at least partially sandwiched between the connecting plates 182). In turn, the movable scaffold 128 may pivot between the upper and lower plates 132A, 132B about the hinge pin 134 and the hinge axis A.

Generally, the biased arm 136 is supported on and biased relatively outward (e.g., away) from one of the fixed scaffold 126 and the movable scaffold 128 while the contact arm 138 is supported on the opposite scaffold. In other words, if the biased arm 136 is supported on the fixed scaffold 126 (and biased outward or away from the same), the contact arm 138 is supported on the movable scaffold 128, and vice versa. In the illustrated embodiments of FIGS. 6 through 7, the biased arm 136 is supported on the fixed scaffold 126 while the contact arm 138 is supported on the movable scaffold 128.

In certain embodiments, the biased arm 136 includes a rod plunger 184. As shown, the rod plunger 184 may have a linear body extending from a housing chamber 150 defined by the fixed scaffold 126. The contact arm 138 may include a shoulder extending parallel to and coaxially with the hinge pin 134, such as between the connecting plates 182. Thus, the shoulder may define a hinge joint 188. The shoulder may include an arcuate contact face 190 directed toward the rod plunger 184. The contact face may define a plurality of circumferentially spaced recess pockets 192 within which the rod plunger 184 may be selectively received. In optional embodiments, the recess pockets 192 include a center pocket 192A. In turn, at a neutral, unpivoted position, a forward end of the rod plunger 184 may sit within the center pocket 192A. Moreover, an initial “breaking” force may be required to pivot the movable scaffold 128 from the neutral, unpivoted position.

When assembled, the biased arm 136 may be biased toward the contact arm 138. For instance, the biased arm 136 may be biased perpendicular to the hinge axis A, as shown. An elastic element or spring (not pictured) may provide the biasing force. Generally, any suitable biasing spring may be provided (e.g., within the housing chamber 150 of the fixed scaffold 126). For instance, the biasing spring may include or be provided as a helical compression spring, leaf spring, pneumatic cylinder, deformable or elastic polymer, etc.

In certain embodiments, a lockout assembly 170 is included with the ilium segment 124. For instance, a pair of grooves may be provided between the fixed and movable scaffolds 126, 128 to receive a latch 176, locking the scaffolds 126, 128 or otherwise restricting relative movement thereof. In the illustrated embodiments, a first groove 172 is defined on the fixed scaffold 126. Specifically, the first groove 172 is defined by a first collar 194 that is joined (e.g., fixed relative to) the fixed scaffold 126, as shown. A second groove 174 is defined on the movable scaffold 128 (e.g., by a second collar 196 joined to the movable scaffold 128). The first groove 172 and the second groove 174 may be defined perpendicular to the hinge axis A. Moreover, in a neutral, unpivoted position, the first and second grooves 172, 174 may be mutually aligned. The latch 176 may include or be provided as a slidable pin that is slidable perpendicular to the hinge axis A (e.g., on the first collar 194). In turn, at the neutral, unpivoted position, the latch 176 may be simultaneously received through the first groove 172 and the second groove 174 to lock the movable scaffold 128 relative to the fixed scaffold 126.

Returning generally to FIGS. 1 through 7, in optional embodiments, the ilium segment 124 includes a simulated hip pocket 200. In the illustrated embodiments, the simulated hip pocket 200 includes a socket scaffold 202. For instance, the socket scaffold 202 may extend (e.g., inward) from an upper portion of the ilium segment 124. Specifically, the socket scaffold 202 may extend from a portion of the movable scaffold 128, such as at a location between the tactile joint 130 and the terminal end of the movable scaffold 128. When assembled, the socket scaffold 202 may be fixed relative to the movable scaffold 128 (e.g., as an integral or unitary member therewith). Thus, pivoting or rotation of the movable scaffold 128 (e.g., relative to the fixed scaffold 126 or simulated skeletal frame 110 generally) may be followed by or correspond with rotation of the socket scaffold 202. A socket cup 204 (FIG. 1) may be attached to the socket scaffold 202 and define a simulated socket recess, such as to receive a simulated femur segment 210. In turn, movement of the simulated pelvis may accurately be reflected at the simulated femur segment 210 or a simulated leg in general.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A pelvis training assembly for a manikin, the pelvis training assembly comprising:
a central frame segment; and
an ilium segment attached to the central frame segment, the ilium segment comprising
a fixed scaffold extending from the central frame segment,
a movable scaffold spaced apart from the central frame segment, and
a tactile joint defining a hinge axis and pivotably attaching the movable scaffold to the fixed scaffold to selectively pivot about the hinge axis, the tactile joint comprising
a biased arm supported on and biased outward from one of the fixed scaffold and the movable scaffold, and
a contact arm supported on an opposite of the fixed scaffold and the movable scaffold in frictional contact with the biased arm to generate haptic feedback with pivoting of the tactile joint about the hinge axis.

2. The pelvis training assembly of claim 1, wherein the biased arm is biased in a direction perpendicular to the hinge axis.

3. The pelvis training assembly of claim 1, wherein the biased arm comprises a tapered plunger having a pair of prongs extending from a centered recess.

4. The pelvis training assembly of claim 3, wherein the contact arm comprises a static pin selectively received within the centered recess.

5. The pelvis training assembly of claim 1, wherein the biased arm comprises a spring-loaded rod.

6. The pelvis training assembly of claim 5, wherein the contact arm defines hinge joint defining a plurality of circumferentially spaced recess pockets.

7. The pelvis training assembly of claim 1, wherein the ilium segment further comprises a lockout assembly, the lockout assembly comprising
a first groove defined on the fixed scaffold and a second groove defined on the movable scaffold, and
a latch movably disposed on the ilium segment in selective simultaneous receipt within the first groove and the second groove.

8. The pelvis training assembly of claim 7, wherein the latch comprises a slidable pin that is slidable along a direction parallel to the hinge axis.

9. The pelvis training assembly of claim 7, wherein the latch comprises a slidable pin that is slidable along a direction perpendicular to the hinge axis.

10. The pelvis training assembly of claim 1, wherein the ilium segment further comprises a simulated hip pocket to receive a simulated femur segment.

11. A training manikin comprising:
a manikin body comprising a simulated skeletal frame, a torso section extending about a first portion of the simulated skeletal frame, and a pelvis section extending about a second portion of the simulated skeletal frame below the torso section, the pelvis section comprising
a central frame segment of the simulated skeletal frame, and
an ilium segment attached to the central frame segment, the ilium segment comprising
a fixed scaffold extending from the central frame segment,
a movable scaffold spaced apart from the central frame segment, and
a tactile joint defining a hinge axis and pivotably attaching the movable scaffold to the fixed scaffold to selectively pivot about the hinge axis, the tactile joint comprising
a biased arm supported on and biased outward from one of the fixed scaffold and the movable scaffold, and
a contact arm supported on an opposite of the fixed scaffold and the movable scaffold in frictional contact with the biased arm to generate haptic feedback with pivoting of the tactile joint about the hinge axis.

12. The training manikin of claim 11, wherein the biased arm is biased in a direction perpendicular to the hinge axis.

13. The training manikin of claim 11, wherein the biased arm comprises a tapered plunger having a pair of prongs extending from a centered recess.

14. The training manikin of claim 13, wherein the contact arm comprises a static pin selectively received within the centered recess.

15. The training manikin of claim 11, wherein the biased arm comprises a spring-loaded rod.

16. The training manikin of claim 15, wherein the contact arm defines hinge joint defining a plurality of circumferentially spaced recess pockets.

17. The training manikin of claim 11, wherein the ilium segment further comprises a lockout assembly, the lockout assembly comprising
a first groove defined on the fixed scaffold and a second groove defined on the movable scaffold, and
a latch movably disposed on the ilium segment in selective simultaneous receipt within the first groove and the second groove.

18. The training manikin of claim 17, wherein the latch comprises a slidable pin that is slidable along a direction parallel to the hinge axis.

19. The training manikin of claim 17, wherein the latch comprises a slidable pin that is slidable along a direction perpendicular to the hinge axis.

20. The training manikin of claim 11, wherein the ilium segment further comprises a simulated hip pocket to receive a simulated femur segment.
